(19) United States
(12) Patent Application Publication
(10) Pub. No.: US 2003/0230015 A1
(43) Pub. Date: Dec. 18, 2003

(54) Louver card

(76) Inventor: Mordeckai Mouyal, Tel Aviv (IL)

Correspondence Address: B. MOSS USA, Inc, 4th Floor, 379 Fifth Avenue, New York, NY, 10016, US

(21) Appl. No.: 10/167,518

(22) Filed: Jun. 12, 2002

(51) Int. Cl. G09F 7/00

(52) U.S. Cl. 40/488

(57) ABSTRACT

The Louver card consists of a folding card made of two sections of essentially identical dimensions, where one of the sections is fitted with an opening, and of an insert arranged between the sections with overlapping lamellae and with a first image surface being visible through the opening. The lamellae, through the use of a driving element which protrudes from the folding card and which is shaped as an iris diaphragm, move between an opened and closed position, whereby a second image carrying surface becomes visible in the open position and is covered in the closed position.

### FIELD OF INVENTION

This invention relates to the field of advertising and promotional techniques and, more particularly to a the field of louver cards. The louver card consists of a folding card made of two sections of essentially identical dimensions, one of them being fitted with an opening, and of an insert arranged between the sections with overlapping lamellae, a first image surface being visible through the opening. The lamellae are movable between an open and a closed position, being driven by a driving element protruding from the folding card and shaped as an iris diaphragm, so a second image carrying surface is made visible in the open position and becomes, respectively, covered in a closed position.

### BACKGROUND OF THE INVENTION

Such a louver card is known from the DE 92 16 101 U1. The lamellae of this already known louver card are fastened to a slide shutter with equally spaced openings arranged on a circle. The openings of the slide shutter are approximately of the same size with the lamella openings. The slide shutter and the lamellae are interconnected in a second connection domain through a connecting piece entering the opening of the sliding shutter and the longitudinal opening of the lamellae, so they can be jointly shifted along the link enabling rotation with respect to one another.

Over a second connecting piece in the first pivoting center, whose design is identical with the connecting piece in the second connection domain, the lamellae are connected through a circular opening with a beneath arranged holder.

The holder has identical round openings in the places corresponding to the openings of the sliding shutter, through which openings the lamellae are pivot-connected to the holder. Rivets made of metal are used as connecting pieces. The rivets, which pass through the two openings of the lamellae and the respective opening of the holder and of the slide shutter, hold together the parts to be connected due to their enlarged ends.

The shortcoming of this already known louver card is the use of metal rivets to fasten the lamellae to the slide shutter, since insertion of such rivets in the said louver card is a very labor-consuming operation.

Proceeding from this state-of-the-art, the goal of the invention is to develop a louver card, of the same kind, which could be made of merely one single material in a simple and cost-saving way.

The solution of this task envisages that, on the one hand, the lamellae are equally spaced in a holding piece and, on the other hand, the lamellae are connected with a driving element. The connection between the lamellae, on one hand, and the holding piece, respectively the driving element, on the other hand, is made through cuts in the lamellae, in the holding piece and in the driving element and the connections between these parts are of the plug-in type.

The louver card according to the invention features connections between the lamellae, on one hand, and the holder, respectively, the driving element on the other hand; this connection consist of two cuts in the lamellae and every time a cut in the corresponding parts of the holder, respectively of the driving element. Thus, the lamellae are suitable for plug-in connection with these component parts.

It is preferably envisaged that every lamella end to be connected with the driving element or the holder shall have two cuts arranged opposite to one another. Particularly, the arrangement of the cuts is collinear.

Another distinctive feature of the invention is the round-shaped form of the holder.

According to another distinctive feature of the invention, the holder has four lugs resting on the folding card. This secures the holder against rotation with regard to the folding card without any additional connecting elements, for instance, glued-on points or other things like that.

Another distinctive feature of the invention is the arrangement of the second image surface on a card element in such a way that it cannot rotate inside the folding card between the holder and the driving element.

The driving element is accommodated inside the folding card by means of a central strap in the card element that enters a slot in the driving element in such a way, that the driving element can rotate restrictedly around the strap with respect to the card element.

This design makes unnecessary the use of rivets or like items made of other materials to fasten the two design components in this connection domain too.

Finally, according to another distinctive feature of the invention, it is envisaged that the card element shall be connected with the holder in order to enable simple manufacturing of the louver card from as few as possible components to be assembled.

Other distinctive feature and advantages of the invention can be derived from the description of the pertaining Figures in a preferably implementation of the louver card.

### SUMMARY

In accordance with the present invention, the Louver card consists of a folding card made of two sections of essentially identical size, where one of the sections has an opening whereby an insert is arranged between the sections with overlapping lamellae and with a first image surface being visible through the opening. Through the use of a driving element which protrudes from the folding card and which is shaped as an iris diaphragm, the lamellae are enabled to move between an open and closed position, whereby a second image carrying surface becomes visible in the open position and is covered in the closed position.

### DRAWINGS

The Figures show:

FIG. 1 General view of a louver card in the first position.

FIG. 2 The louver card according to FIG. 1 in the second position.

FIG. 3A folding card for the louver card according to FIGS. 1 and 2.

FIG. 4A holder with a card element and a second image surface for the louver card according to FIGS. 1 and 2.

FIG. 5A driving element for the louver card according to FIGS. 1 and 2.

FIG. 6A lamella for the louver card according to FIGS. 1 and 2.

FIG. 7 An assembly of six lamellae according to FIG. 6 in the first open position.

FIG. 8 An assembly of six lamellae according to FIG. 7 in a second, half-open position.

FIG. 9 An assembly of six lamellae according to FIGS. 7 and 8 in more open position.

FIG. 10 The holder with the card element and the second image surface according to FIG. 4 together with the six lamellae according to the FIGS. 7 through 9 in assembly. General view.

FIG. 11 The holder with the card element and the second image surface together with the installed lamellae according to the FIG. 10. Front view.

FIG. 12 The holder with the card element and the second image surface and the lamellae. Rear view.

FIG. 13 The insert for the folding card according to FIG. 3.

FIG. 14 The insert according to FIG. 13 in the first mounting position.

FIG. 15 The insert according to FIGS. 13 and 14 in the second mounting position.

FIG. 16 The insert according to FIGS. 13 through 15 in the first lamellae position.

FIG. 17 The insert according to FIG. 16 in the second lamellae position.

### DETAILED DESCRIPTION

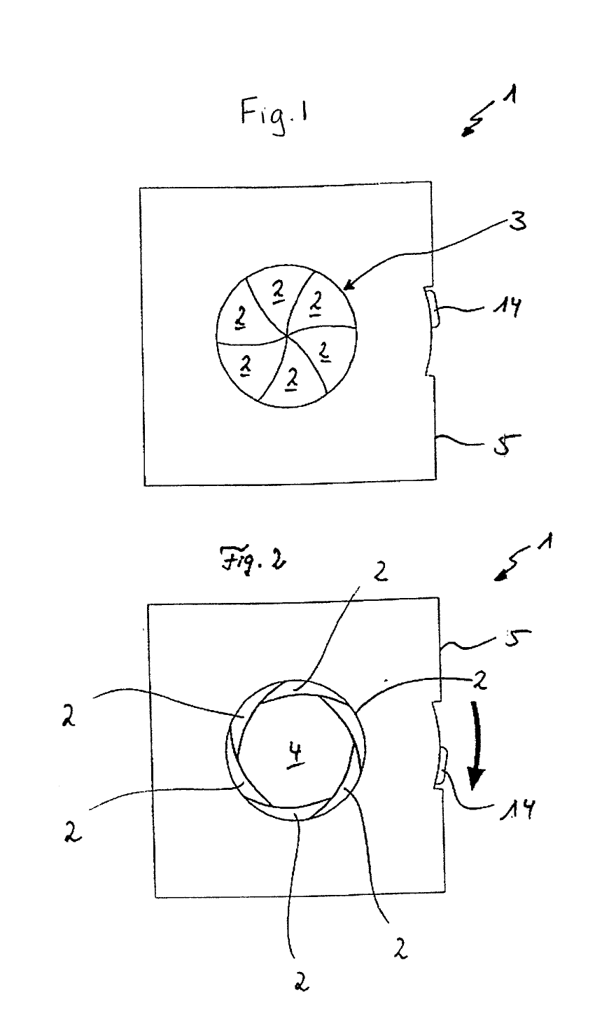

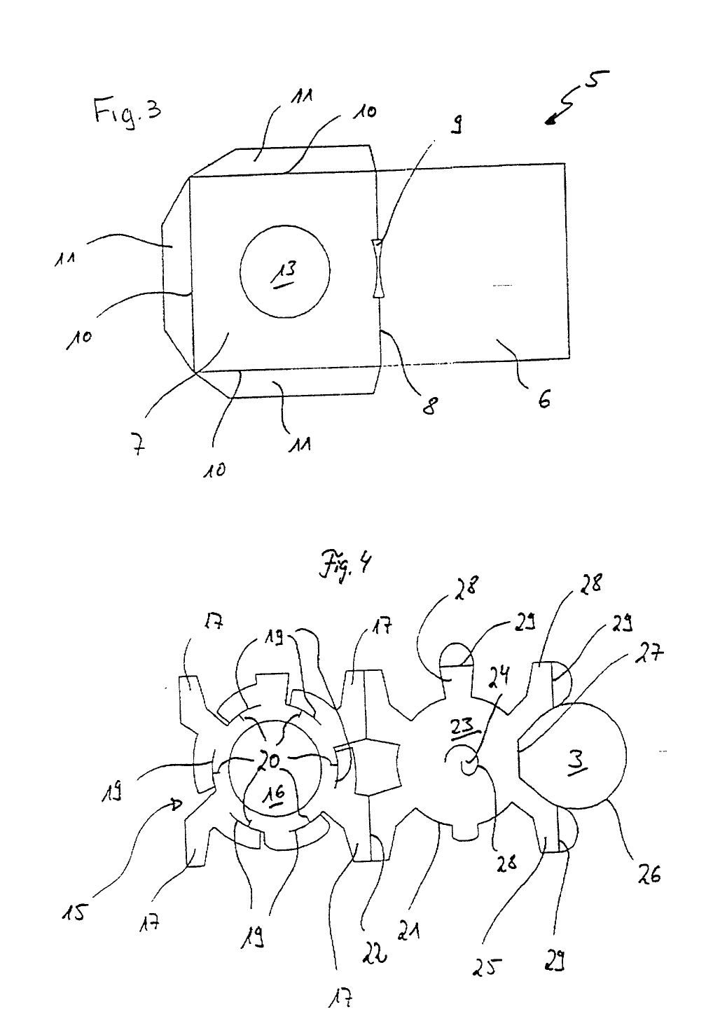

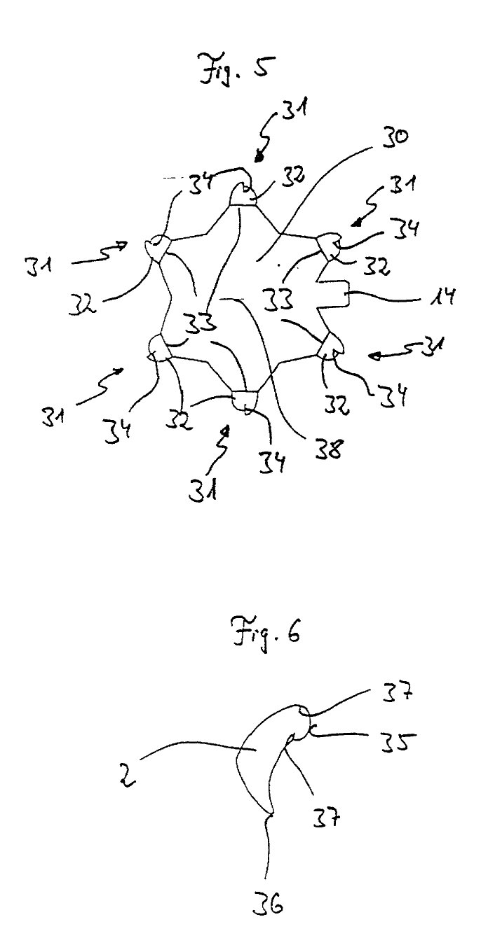

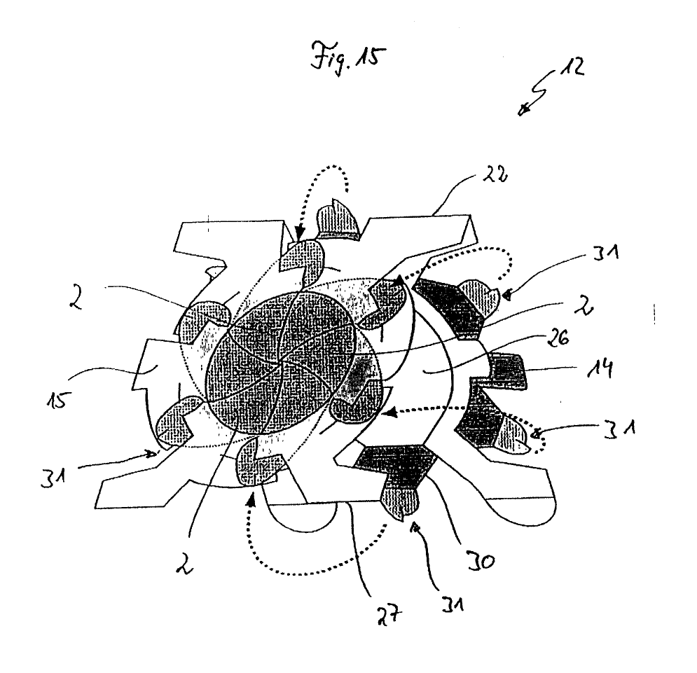

A louver card 1, according to FIGS. 1 through 17, shows a first image surface 3 and a second image surface 4 made of the overlapping lamellae arranged inside a folding card 5. The folding card 5 consists of two sections 6 and 7, essentially of the same size, which are interconnected along a fold. Both the sections 6 and 7 have a recess 9 in the middle of the fold 8.

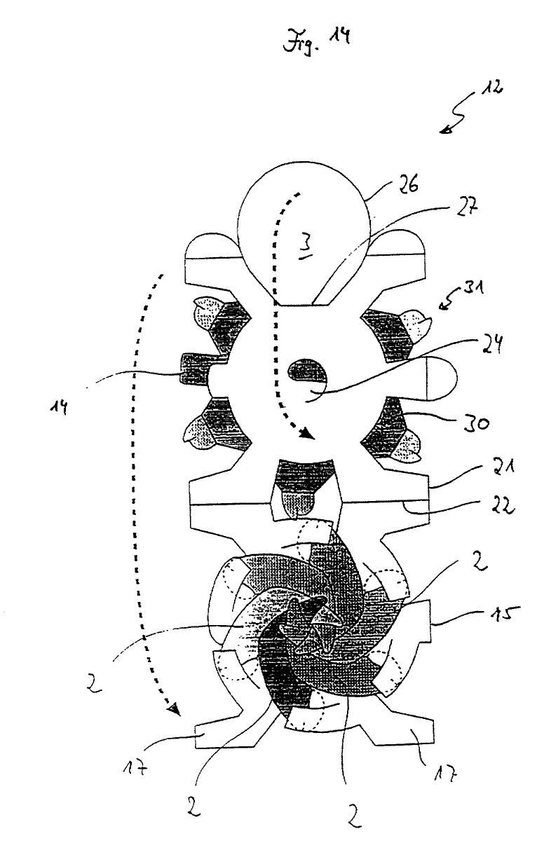

The section 7 shows also folding tongues 11 on the three free outer edges 10, which tongues are skewed on their narrow ends in such a way, that the folding tongues 11 are applied over the surface of the section 7. They can be connected with the folded-on section 6 in order to form a hollow space between the two sections 6 and 7, suitable to accommodate one of the inserts 12 shown in the FIGS. 13 through 17.

The folding card 5 features also an opening 13 in the central zone of the section 7.

An observer can activate the sliding shutter 14 arranged at one side of the louver card 1 in order to affect the first image surface 3 and, thus, to cover, and respectively, to uncover the second image surface arranged beneath. The slide shutter 14 is arranged in the zone of the recess 9 of the folding card 5, in such a way that it protrudes from the recess 9.

The changeable first image surface 3 is located in the zone of the opening 13 being made of separate lamellae 2, that are shaped as iris diaphragm in the considered implementation form.

The insert 12 whose component parts are described hereinafter is enclosed in the folding card 5.

The insert 12 has a holder 15. The holder 15 is essentially a ring-shaped element having a central opening 16 and two pairs of lugs 17, which are diametrically disposed.

Further, in the zone of the rim 18, surrounding the opening 16, the holder 15 has for each lamella 2 a circular-arc cut 19 opened outwards. Within each cut 19 there is another cut 20, square to the first one, and located approximately in the middle of the first cut 19. This cut extends from the cut 19 in the direction of the center of the opening 16. A card element 21, which makes one piece with the holder, can fold over the folding edge 22 being hinged to the two lugs 17 of the holder 15.

The card element 21 has an essentially round card surface 23 with a strap 24 in the middle formed by the circular-arc cut 25, particularly, of sickle-shaped form. The card element 21 features another card surface 26 disposed on its lateral surface looking towards the holder 15. This card surface 26 carries a second image surface and is also connected with the card element 21 by the folding edge 27, so the card surface 26 can fold along the folding edge 27 with respect to the card element 27.

Finally, the card element 21 features other folding elements 28, whose free ends can fold around the folding edges 29.

Another component of the insert 21 is the driving element 30 shown in FIG. 5. The driving element 30 is essentially star-shaped and has a number of equally spaced tips 31 corresponding to the number of lamellae. Each tip 31 has an essentially half-ring-shaped folding element 32, which can fold along the folding edge 33 in the direction towards the center of the driving element 30.

A cut 34 is made in the free middle zone of each folding element 32 in the direction towards the center of the driving element 30.

Finally, it can be seen that the sliding shutter 14 is disposed between two neighboring tips 31 of the driving element 30.

Six sickle-shaped lamellae 2, according to FIG. 6, can be fastened to the driving element 30, and each lamella 2 in conformity with the FIG. 6 is essentially sickle-shaped. Each lamella 2 has a half-circular end 35 and a sharp end 36. In the zone of the half-circular end 35, each lamella has two collinearly arranged cuts 37.

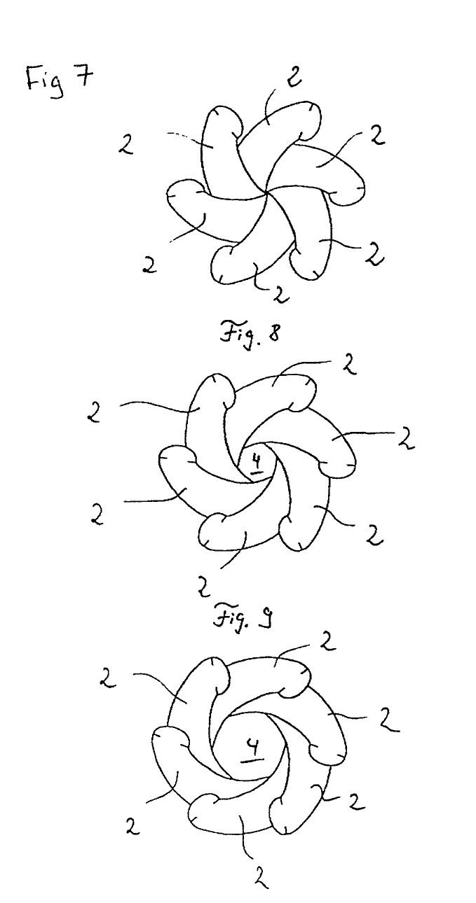

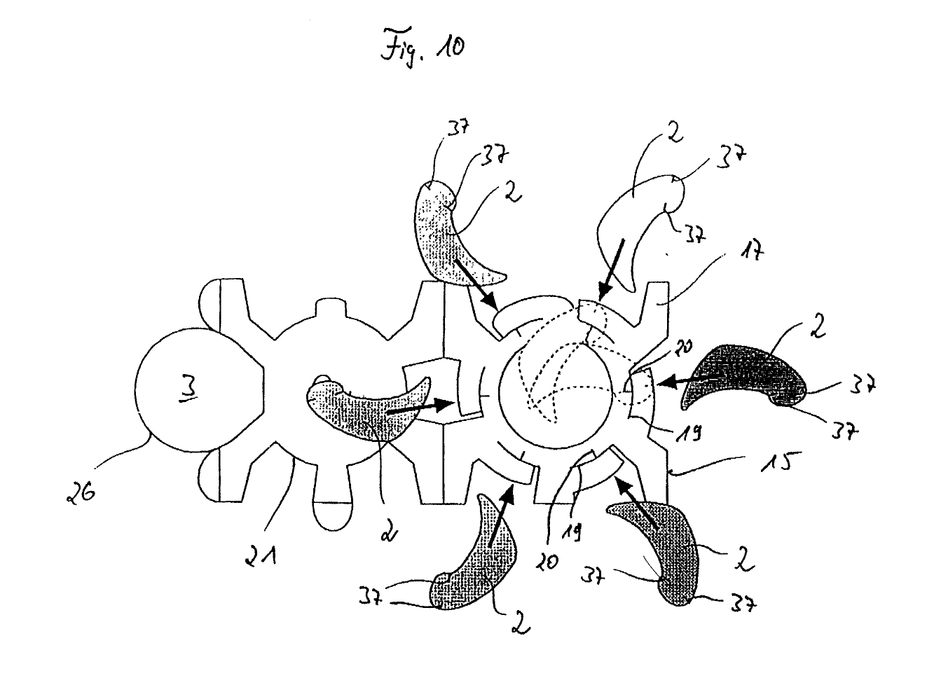

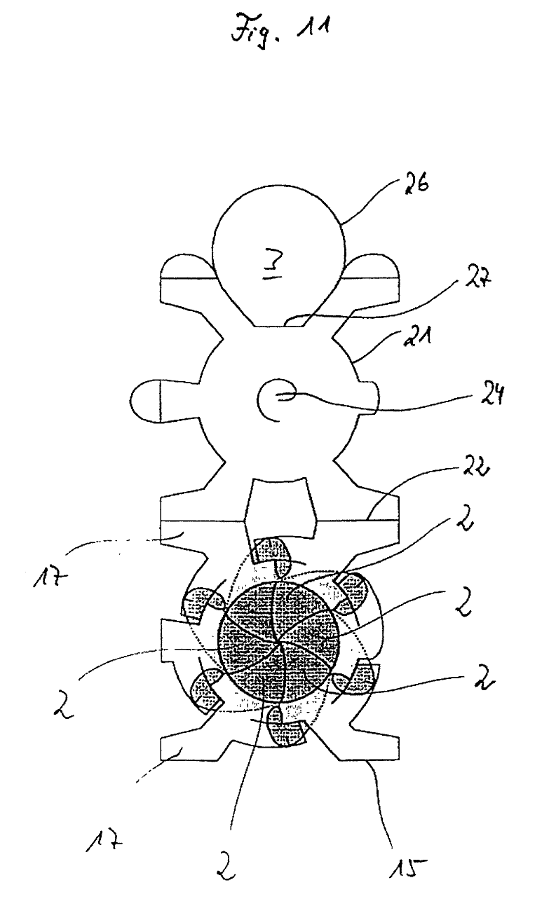

The FIGS. 7 through 9 show the arrangement of the lamellae 2 with respect to one another. FIG. 7 shows the arrangement of the lamellae in a closed position, which enables the observer to view the first image surface 3. Then, the lamellae 2 are shifted to the position according to FIG. 8 by moving the slide shutter 14, thus enabling the observer to view a part of the second image surface 4. Moving further the slide shutter 14 results in enlarging the opening between the lamellae 2, so a larger part of the image surface 4 can be seen.

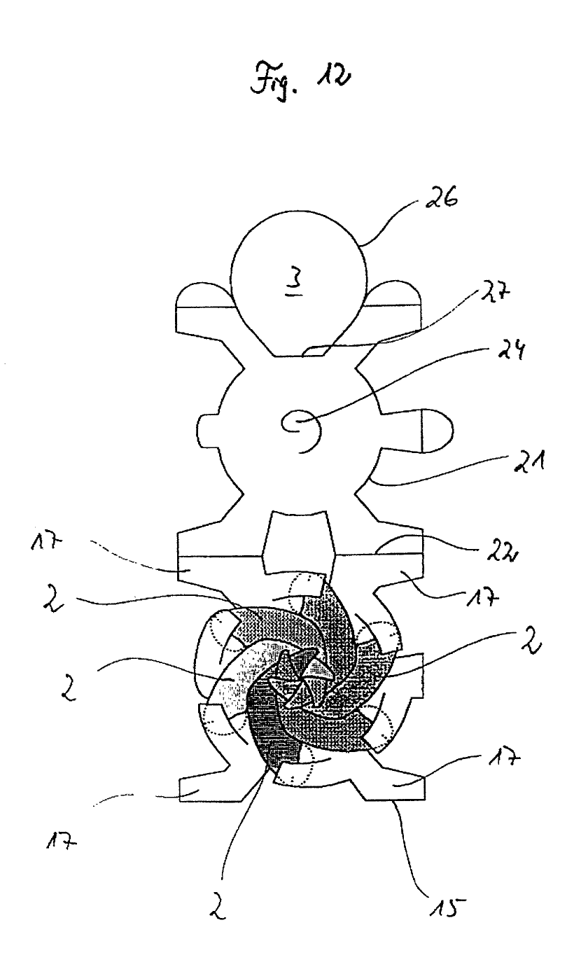

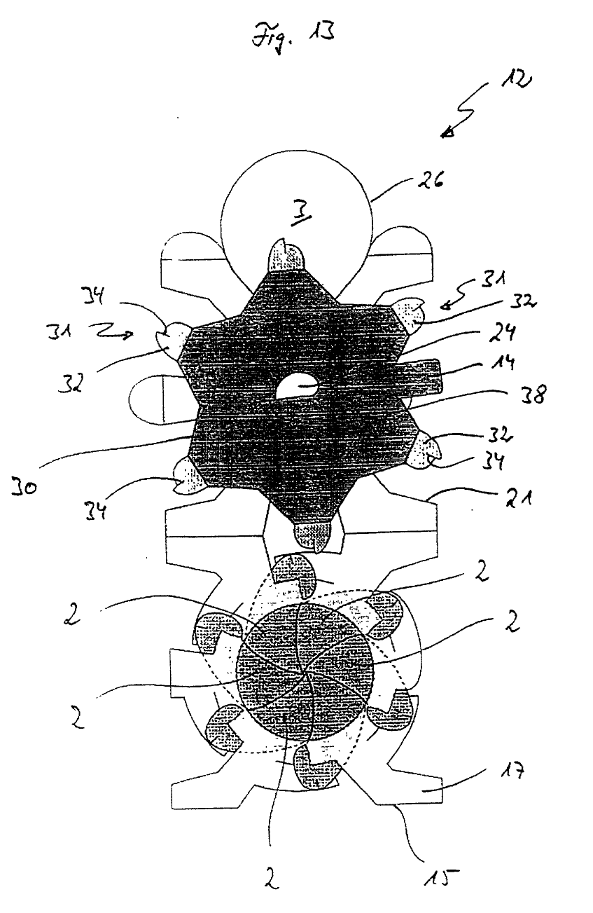

FIG. 10 shows the connection of the lamellae 2 to the holder 15. With respect to the holder 15 the lamellae 2 are arranged with their sharp ends 36 in the direction of the opening 16 in such a way that a cut 37 enters the cut 19 and subsequently the cut 20 and is seized there. The holder 15 with the inserted lamellae 2 is shown in FIGS. 11 and 12 twice, in front view according to FIG. 11 and in rear view according to FIG. 12. After having fastened the lamellae 2 to the holder, the driving element 30 is fitted to the card element 21 in such a way that the strap 24 is inserted in the corresponding slot 38. This results in a restricted rotation ability of the driving element with respect to the card element 21.

Now, the lamellae 2 are on the surface of the holder 15 and the driving element 30 on the opposite surface of the card element 21. The next step is to fold the insert 12 formed this way along the folding edges 22 and 27.

Thus the card surface 26 becomes folded at first over the card surface 23. The card surface 26 is put on the very card surface 23, which is opposite to the surface resting on the driving element 30.

Subsequently, the card element 21 with the already folded-on card surface 26 is folded in the same direction over the surfaces of the lamellae 2 along the folding edge 22. The card surface 26 is now positioned between the card surface 23 and the lamellae 2, which are partially covered by the holder 15. Then the folding elements 32 of the driving element 30 are folded in the direction of the half-circular ends 35 of the lamellae 2 in order to insert the cuts 34 into the still free cuts 37.

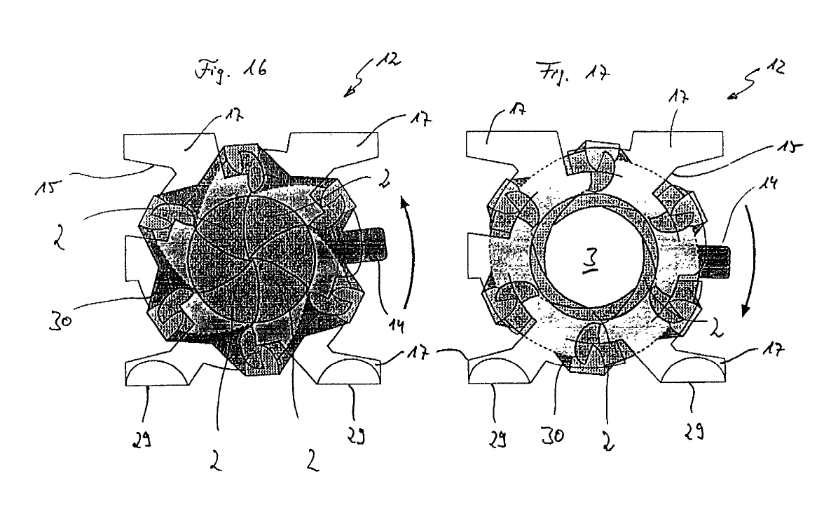

The insert 12 formed this way is shown in FIGS. 16 and 17 in two positions, with closed and open lamellae 2. The insert 12 can be then introduced into the folding card 5 so that the slide shutter protrude through the opening formed by the activation recess 9 of the lamellae 2.

For this purpose, the sections 6 and 7 of the folding card 5 can be glued-on in the zone of the folds 11. It goes without saying, that the insert 12 is fitted into the folding card 5 in such a way, that the lamellae 2 are arranged directly in the zone of the opening 13.

1. Louver card consisting of a folding card made of two sections, essentially identical in size, one of the sections having an opening and an insert arranged between the sections and the overlapping lamellae, with a first image surface that can be seen through the opening, the lamellae being enabled to move between an open and a closed position driven by a driving element shaped as an iris diaphragm in order to cover in the closed position, respectively, to uncover in the open position a second image surface, which louver card is charcterized by the lamellae (2) being, on one hand, located equally spaced in a holder (15) and, on the other hand, connected with the driving element (30), where the connection between the lamellae (2), on the one hand, and the holder (15), respectively the driving element (30), on the other hand, is achieved by the cuts (19, 20, 34, 37) in the lamellae (2), in the holder (15) and in the driving element (30), enabling plug-in connections between the component parts.

2. Louver card according to claim item 1, characterized by every lamella (2) having two opposite cuts (37) at its connecting end (35) with the driving element (30) and the holder (15).

3. Louver card according to claim item 2, characterized by the cuts (37) being collinearly arranged.

4. Louver card according to claim item 1, characterized by the holder (15) being ring-shaped.

5. Louver card according to claim item 1, characterized by the holder (15) having four lugs (17) securing the holder (15) rest on the folding card (5).

6. Louver card according to claim item 1, characterized by the second image surface (3) being located on a card element (21), which is accommodated in the folding card 5 between the holder (15) and the driving element (30) so it can not rotate.

7. Louver card according to claim item 6, characterized by the card element (21) having a central strap (24) with a slot (38) protruding into the driving element (30) enabling a restricted rotation of the driving element around the strap (24) with respect to the card element (21).

8. Louver card according to claim item 6, characterized by the card element (21) being connected with the holder (15).
